(19) United States
(12) Patent Application Publication
(10) Pub. No.: US 2007/0091277 A1
(43) Pub. Date: Apr. 26, 2007

(54) Luminance based multiple projector system

(76) Inventors: Niranjan Damera-Venkata, Mountain View, CA (US); Nelson Liang An Chang, San Jose, CA (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 11/258,624

(22) Filed: Oct. 26, 2005

(51) Int. Cl. G03B 21/14; G03B 21/26; G03B 21/00

(52) U.S. Cl. 353/69; 353/94

(57) ABSTRACT

A method of displaying a high-resolution image with a multi-projector display system. The method includes determining a luminance profile for each projector, receiving a high-resolution image frame representative of the high-resolution image, and generating for each projector a low-resolution sub-frame corresponding to the high-resolution image frame based on a geometric relationship between the projector and a reference coordinate system and on the luminance profile of the projector. The method includes simultaneously projecting each low-resolution sub-frame onto a target surface with the associated projector, wherein the projectors are configured such that the projected low-resolution sub-frames at least partially overlap on the target surface to form a projected image substantially equal to the high-resolution image.

### BACKGROUND

Two types of projection display systems are digital light processor (DLP) systems, and liquid crystal display (LCD) systems. It is desirable in some projection applications to provide a high lumen level output, but it is very costly to provide such output levels in existing DLP and LCD projection systems. Three choices exist for applications where high lumen levels are desired: (1) high-output projectors; (2) tiled, low-output projectors; and (3) superimposed, low-output projectors.

When information requirements are modest, a single high-output projector is typically employed. This approach dominates digital cinema today, and the images typically have a nice appearance. High-output projectors have the lowest lumen value (i.e., lumens per dollar). The lumen value of high output projectors is less than half of that found in low-end projectors. If the high output projector fails, the screen goes black. Also, parts and service are available for high output projectors only via a specialized niche market.

Tiled projection can deliver very high resolution, but it is difficult to hide the seams separating tiles, and output is often reduced to produce uniform tiles. Tiled projection can deliver the most pixels of information. For applications where large pixel counts are desired, such as command and control, tiled projection is a common choice. Registration, color, and brightness must be carefully controlled in tiled projection. Matching color and brightness is accomplished by attenuating output, which costs lumens. If a single projector fails in a tiled projection system, the composite image is ruined.

Superimposed projection provides excellent fault tolerance and full brightness utilization, but resolution is typically compromised. Algorithms that seek to enhance resolution by offsetting multiple projection elements have been previously proposed. These methods assume simple shift offsets between projectors, use frequency domain analyses, and rely on heuristic methods to compute component sub-frames. The proposed methods do not generate optimal sub-frames in real-time, and do not take into account arbitrary relative geometric distortion and luminance (brightness) variations between the component projectors.

### SUMMARY

One form of the present invention provides a method of displaying a high-resolution image with a multi-projector display system. The method includes determining a luminance profile for each projector, receiving a high-resolution image frame representative of the high-resolution image, and generating for each projector a low-resolution sub-frame corresponding to the high-resolution image frame based on a geometric relationship between the projector and a reference coordinate system and on the luminance profile of the projector. The method includes simultaneously projecting each low-resolution sub-frame onto a target surface with the associated projector, wherein the projectors are configured such that the projected low-resolution sub-frames at least partially overlap on the target surface to form a projected image substantially equal to the high-resolution image.

### BRIEF DESCRIPTION OF THE DRAWINGS

FIG. 1 is a block diagram illustrating an image display system according to one embodiment of the present invention.

FIGS. 2A-2C are schematic diagrams illustrating the projection of two sub-frames according to one embodiment of the present invention.

FIG. 3 is a flow diagram illustrating one embodiment of a process for displaying a high-resolution image according to the present invention.

FIG. 4 is a diagram illustrating a model of an image formation process according to one embodiment of the present invention.

FIG. 5 is a diagram illustrating a process for formation of an initial sub-frame according to the present invention.

FIG. 6 is a flow diagram illustrating one embodiment of a process for determining a relative luminance matrix according to the present invention.

FIG. 7 is a diagram illustrating a model of an image formation process according to one embodiment of the present invention.

FIG. 8 is a diagram illustrating a process for formation of an initial sub-frame according to the present invention.

### DETAILED DESCRIPTION

In the following Detailed Description, reference is made to the accompanying drawings, which form a part hereof, and in which is shown by way of illustration specific embodiments in which the invention may be practiced. In this regard, directional terminology, such as “top,” “bottom,” “front,” “back,” etc., may be used with reference to the orientation of the Figure(s) being described. Because components of embodiments of the present invention can be positioned in a number of different orientations, the directional terminology is used for purposes of illustration and is in no way limiting. It is to be understood that other embodiments may be utilized and structural or logical changes may be made without departing from the scope of the present invention. The following Detailed Description, therefore, is not to be taken in a limiting sense, and the scope of the present invention is defined by the appended claims.

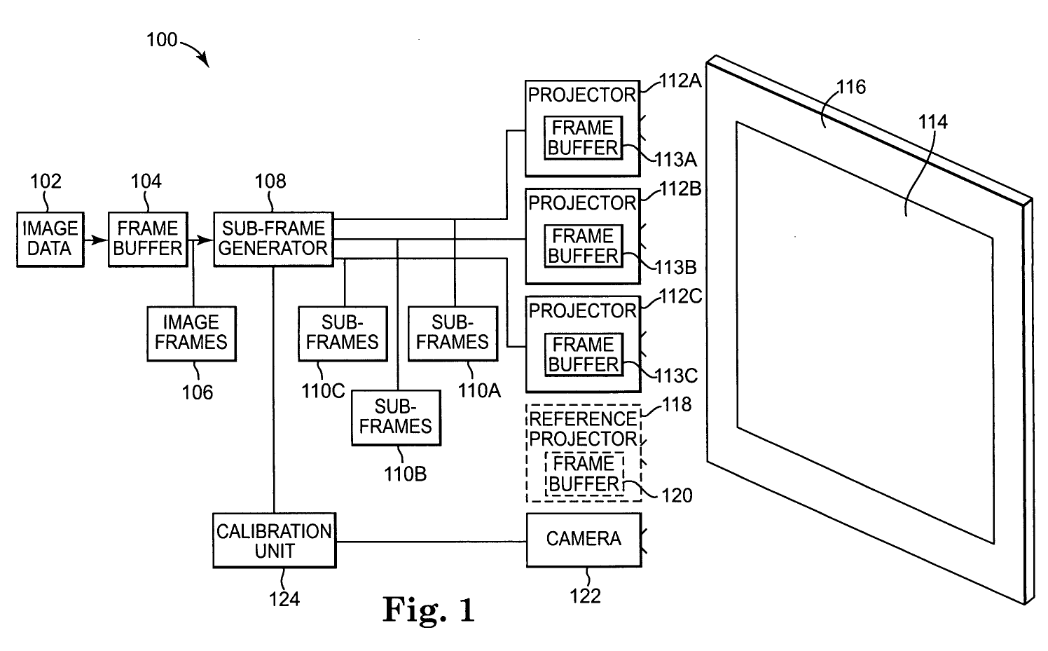

FIG. 1 is a block diagram illustrating an image display system 100 according to one embodiment of the present invention. Image display system 100 processes image data 102 and generates a corresponding displayed image 114. Displayed image 114 is defined to include any pictorial, graphical, or textural characters, symbols, illustrations, or other representations of information.

In one embodiment, image display system 100 includes image frame buffer 104, sub-frame generator 108, projectors 112A-112C (collectively referred to as projectors 112), camera 122, and calibration unit 124. Image frame buffer 104 receives and buffers image data 102 to create image frames 106. Sub-frame generator 108 processes image frames 106 to define corresponding image sub-frames 110A-110C (collectively referred to as sub-frames 110). In one embodiment, for each image frame 106, sub-frame generator 108 generates one sub-frame 110A for projector 112A, one sub-frame 110B for projector 112B, and one sub-frame 110C for projector 112C. The sub-frames 110A-110C are received by projectors 112A-112C, respectively, and stored in image frame buffers 113A-113C (collectively referred to as image frame buffers 113), respectively. Projectors 112A-112C project the sub-frames 110A-110C, respectively, onto target surface 116 to produce displayed image 114 for viewing by a user.

Image frame buffer 104 includes memory for storing image data 102 for one or more image frames 106. Thus, image frame buffer 104 constitutes a database of one or more image frames 106. Image frame buffers 113 also include memory for storing sub-frames 110. Examples of image frame buffers 104 and 113 include non-volatile memory (e.g., a hard disk drive or other persistent storage device) and may include volatile memory (e.g., random access memory (RAM)).

Sub-frame generator 108 receives and processes image frames 106 to define a plurality of image sub-frames 110. Sub-frame generator 108 generates sub-frames 110 based on image data in image frames 106. In one embodiment, sub-frame generator 108 generates image sub-frames 110 with a resolution that matches the resolution of projectors 112, which is less than the resolution of image frames 106 in one embodiment. Sub-frames 110 each include a plurality of columns and a plurality of rows of individual pixels representing a subset of an image frame 106.

Projectors 112 receive image sub-frames 110 from sub-frame generator 108 and, in one embodiment, simultaneously project the image sub-frames 110 onto target 116 at overlapping and spatially offset positions to produce displayed image 114. In one embodiment, display system 100 is configured to give the appearance to the human eye of high-resolution displayed images 114 by displaying overlapping and spatially shifted lower-resolution sub-frames 110 from multiple projectors 112. In one form of the invention, the projection of overlapping and spatially shifted sub-frames 110 gives the appearance of enhanced resolution (i.e., higher resolution than the sub-frames 110 themselves).

A problem of sub-frame generation, which is addressed by embodiments of the present invention, is to determine appropriate values for the sub-frames 110 so that the displayed image 114 produced by the projected sub-frames 110 is as close in appearance as possible as to how the high-resolution image frame (e.g., image frame 106) from which sub-frames 110 are derived would appear if displayed directly.

Projector tone curves generally vary from projector to projector. In conventional multi-projector tiled systems, the luminance (L) response of the individual projectors is generally adjusted so as to achieve an image that is seamless in appearance. To achieve this seamless appearance, the luminance responses of the projectors are generally downwardly adjusted to match the luminance response of the weakest projector(s). As such, the minimum luminance (L_{MIN}) provided by each of the projectors is adjusted to equal the L_{MIN}value of the projector having the highest L_{MIN} value, and the maximum luminance (L_{MAX}) provided by each of the projectors is adjusted to equal the L_{MAX} value of the projector having the lowest L_{MAX} value. In other words, with conventional multi-projector tiled systems, the luminance range provided by each of the projectors is adjusted so as to substantially equal the worst combination of the group of multiple projectors. As such, although conventional multi-projector tiled systems increase the resolution of a projected image by increasing the number of pixels employed to display the image, image brightness is sacrificed because the full brightness range of the projectors is not utilized.

In contrast, with a superimposed projector system according to the present invention, the brightness of the desired image ranges from a minimum luminance value (L_{MIN}), which is substantially equal to the sum of the minimum luminance values provided by each of the projects, to a maximum luminance value (L_{MAX}), which is substantially equal to the sum of the maximum luminance values provided by each of the projectors. As such, a superimposed projector system according to the present invention can render a desired image using substantially the full brightness range of the projectors.

In addition to varying between projectors, the luminance response of a single projector is typically non-linear in response to varying gray level inputs. Also, the luminance response of a given projector to a single gray level may vary spatially across the projected image. If these luminance variances are not accounted for, the superimposed multiple projector display system may not be able to utilize the full luminance range when projecting a desired image.

As such, in one embodiment, as will be described in greater detail below, the present invention provides a system and method that accounts for luminance variations between the multiple superimposed projectors when generating sub-frame values for each of the component projectors. By generating sub-frame values in this fashion, an image display system in accordance with the present invention, such as image display system 100, is able to utilize substantially the full combined brightness range of the multiple projectors when displaying a desired image. In one embodiment, the present invention describes algorithms to account for variations in the luminance of a projected image from multiple superimposed projectors.

It will be understood by a person of ordinary skill in the art that functions performed by sub-frame generator 108 may be implemented in hardware, software, firmware, or any combination thereof. The implementation may be via a microprocessor, programmable logic device, or state machine. Components of the present invention may reside in software on one or more computer-readable mediums. The term computer-readable medium as used herein is defined to include any kind of memory, volatile or non-volatile, such as floppy disks, hard disks, CD-ROMs, flash memory, read-only memory, and random access memory.

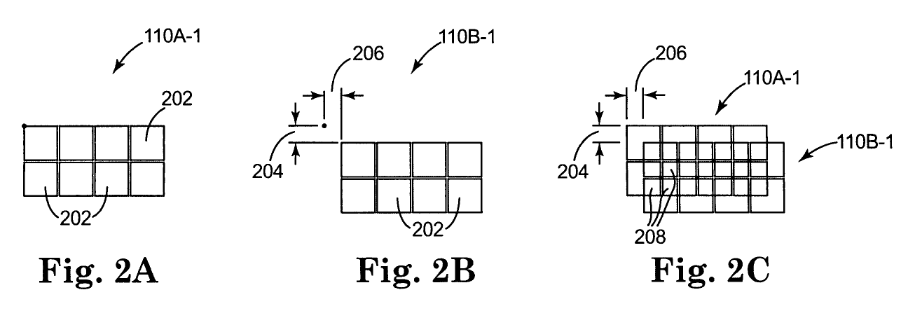

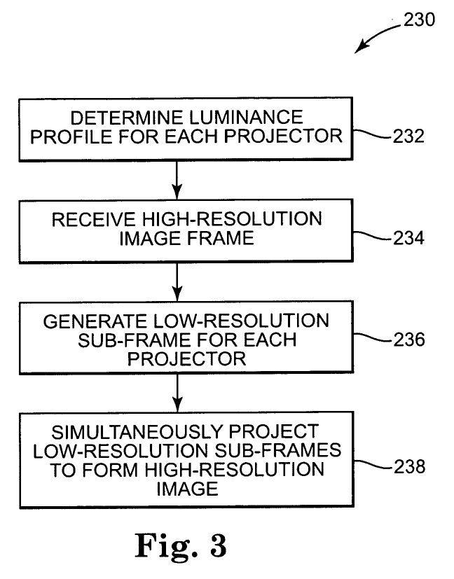

Also shown in FIG. 1 is reference projector 118 with an image frame buffer 120. Reference projector 118 is shown with hidden lines in FIG. 1 because, in one embodiment, projector 118 is not an actual projector, but rather is a hypothetical high-resolution reference projector that is used in an image formation model for generating optimal sub-frames 110, as described in further detail below with reference to FIGS. 2A-2C and 3. In one embodiment, the location of one of the actual projectors 112 is defined to be the location of the reference projector 118.

In one embodiment, display system 100 includes a camera 122 and a calibration unit 124, which are used in one form of the invention to automatically determine a geometric mapping between each projector 112 and the reference projector 118, as described in further detail below with reference to FIGS. 2A-2C and 3.

In one form of the invention, image display system 100 includes hardware, software, firmware, or a combination of these. In one embodiment, one or more components of image display system 100 are included in a computer, computer server, or other microprocessor-based system capable of performing a sequence of logic operations. In addition, processing can be distributed throughout the system with individual portions being implemented in separate system components, such as in a networked or multiple computing unit environment.

In one embodiment, display system 100 uses two projectors 112. FIGS. 2A-2C are schematic diagrams illustrating the projection of two sub-frames 110 according to one embodiment of the present invention. As illustrated in FIGS. 2A and 2B, sub-frame generator 108 defines two image sub-frames 110 for each of the image frames 106. More specifically, sub-frame generator 108 defines a first sub-frame 110A-1 and a second sub-frame 110B-1 for an image frame 106. As such, first sub-frame 110A-1 and second sub-frame 110B-1 each include a plurality of columns and a plurality of rows of individual pixels 202 of image data.

In one embodiment, as illustrated in FIG. 2B, when projected onto target 116, second sub-frame 110B-1 is offset from first sub-frame 110A-1 by a vertical distance 204 and a horizontal distance 206. As such, second sub-frame 110B-1 is spatially offset from first sub-frame 110A-1 by a predetermined distance. In one illustrative embodiment, vertical distance 204 and horizontal distance 206 are each approximately one-half of one pixel.

As illustrated in FIG. 2C, a first one of the projectors 112A projects first sub-frame 110A-1 in a first position and a second one of the projectors 112B simultaneously projects second sub-frame 110B-1 in a second position, spatially offset from the first position. More specifically, the display of second sub-frame 110B-1 is spatially shifted relative to the display of first sub-frame 110A-1 by vertical distance 204 and horizontal distance 206. As such, pixels of first sub-frame 110A-1 overlap pixels of second sub-frame 110B-1, thereby producing the appearance of higher resolution pixels 208. The overlapped sub-frames 110A-1 and 110B-1 also produce a brighter overall image 114 than either of the sub-frames 110 alone. In other embodiments, more than two projectors 112 are used in system 100, and more than two sub-frames 110 are defined for each image frame 106, which results in a further increase in the resolution and brightness of the displayed image 114.

In one form of the invention, sub-frames 110 have a lower resolution than image frames 106. Thus, sub-frames 110 are also referred to herein as low-resolution images or sub-frames 110, and image frames 106 are also referred to herein as high-resolution images or frames 106. It will be understood by persons of ordinary skill in the art that the terms low resolution and high resolution are used herein in a comparative fashion, and are not limited to any particular minimum or maximum number of pixels.

In one form of the invention, display system 100 produces a superimposed projected output that takes advantage of natural pixel mis-registration to provide a displayed image 114 with a higher resolution than the individual sub-frames 110. In one embodiment, image formation due to multiple overlapped projectors 112 is modeled using a signal processing model. Optimal sub-frames 110 for each of the component projectors 112 are estimated by sub-frame generator 108 based on the model, such that the resulting image predicted by the signal processing model is as close as possible to the desired high-resolution image to be projected.

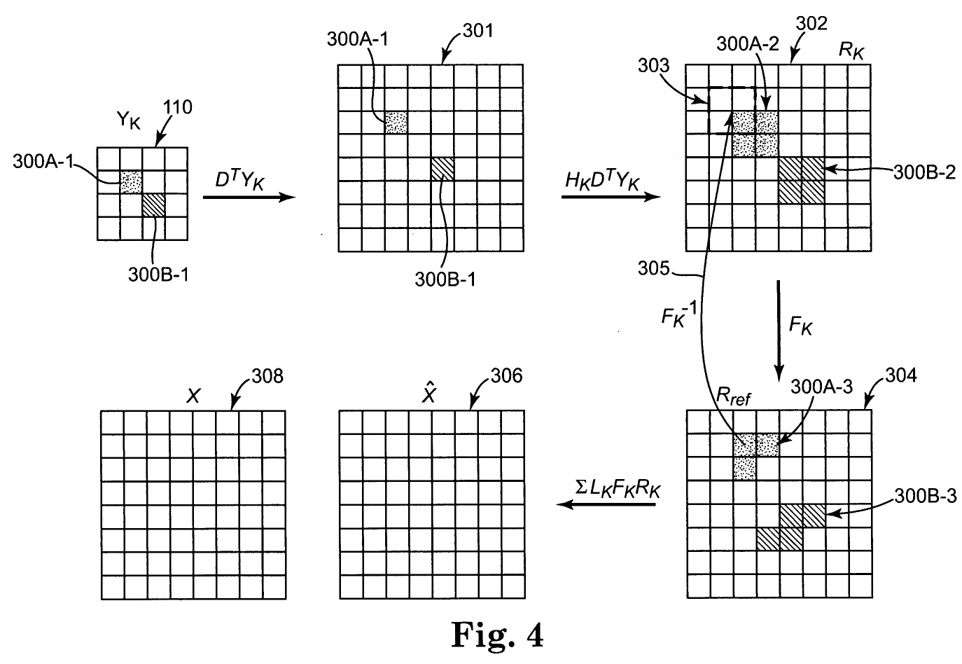

In one embodiment, sub-frame generator 108 is configured to generate sub-frames 110 based on the maximization of a probability that, given a desired high resolution image, a simulated high-resolution image that is a function of the sub-frame values, is the same as the given, desired high-resolution image. If the generated sub-frames 110 are optimal, the simulated high-resolution image will be as close as possible to the desired high-resolution image. The generation of optimal sub-frames 110 based on a simulated high-resolution image and a desired high-resolution image is described in further detail below with reference to FIG. 4.

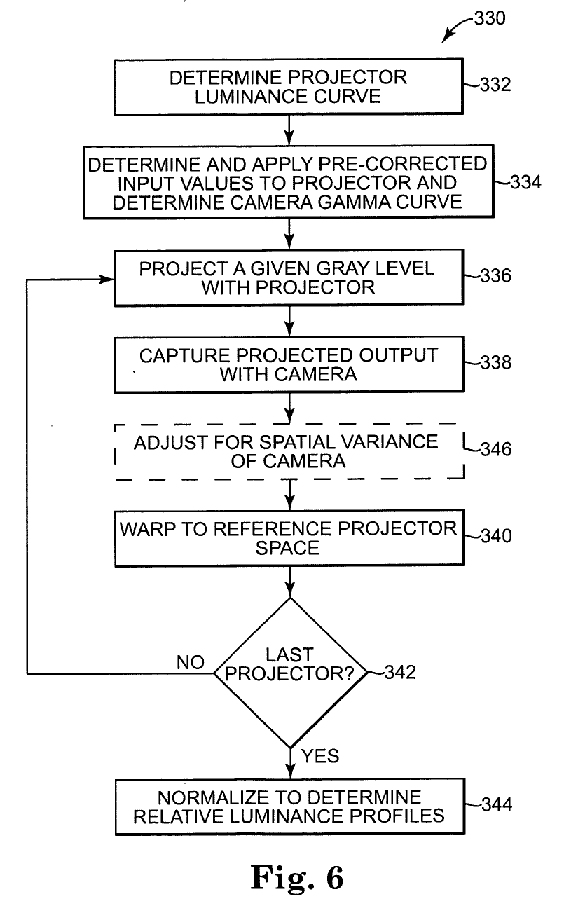

FIG. 3 is a flow diagram describing one embodiment of a process 230 for displaying a high-resolution image with a superimposed multi-projector display system according to the present invention. Process 230 begins at 232 where a luminance profile is determined for each projector. A description of one embodiment of a process for determining the luminance profiles is described in greater detail below with reference to FIG. 6. At 234, and as described by FIGS. 4-5 and 7-8, the projector system receives a high-resolution image frame which is representative of the high-resolution image to be projected.

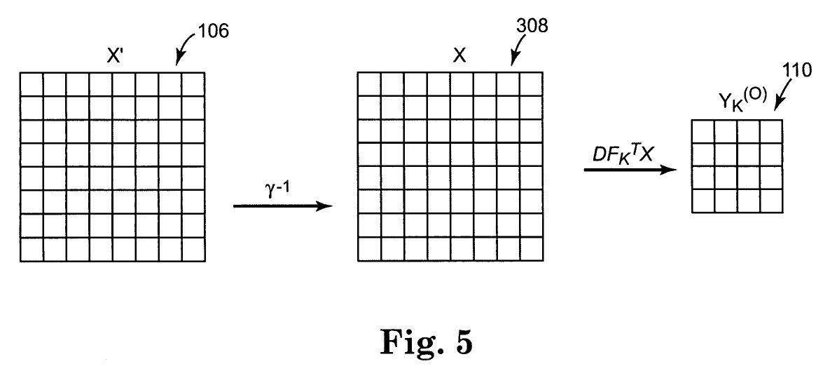

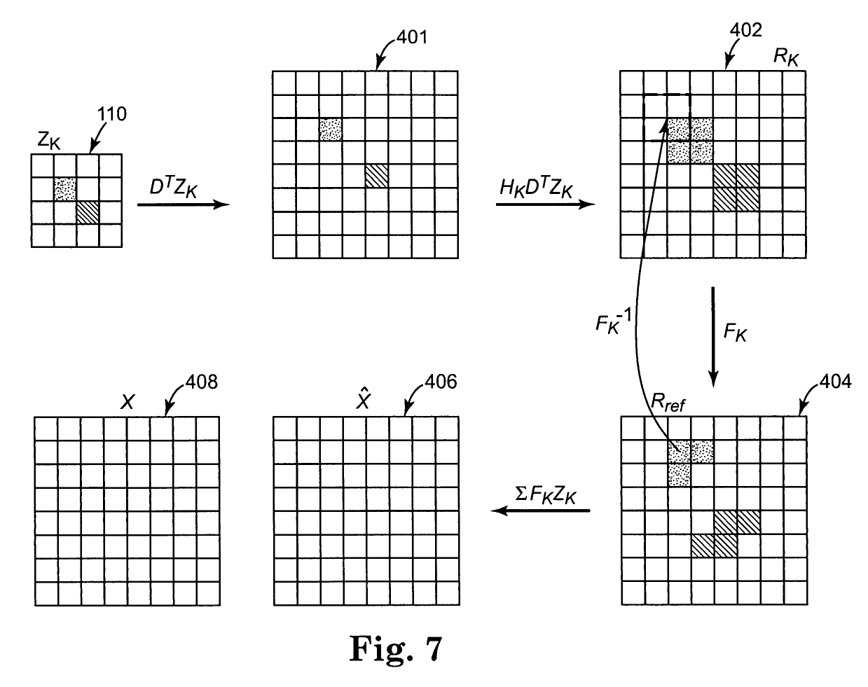

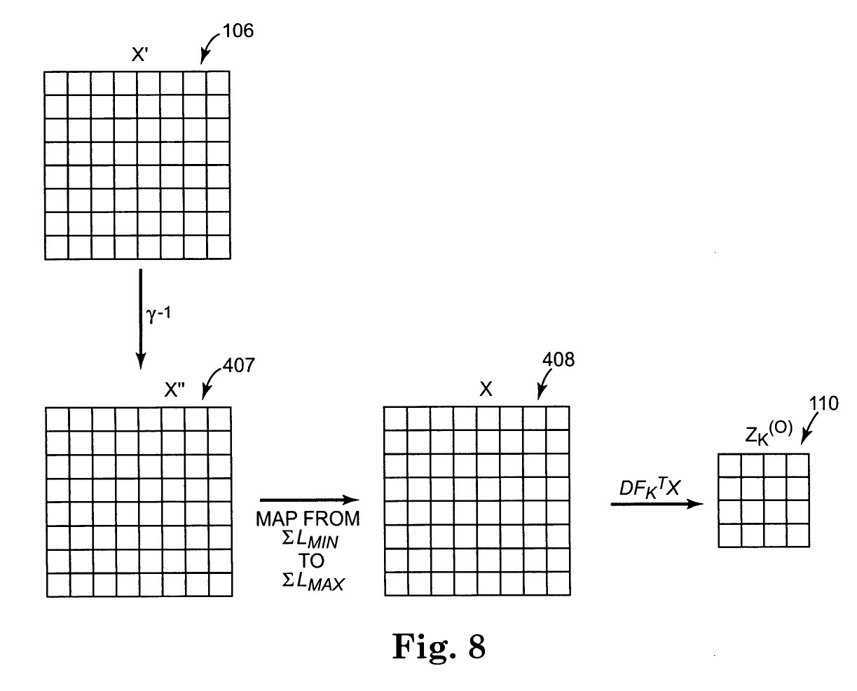

At 236, a low-resolution sub-frame is generated from the high-resolution image frame for each projector based on a geometric relationship between the projector and a reference coordinate system and on the projector's luminance profile. In one embodiment, the geometric relationship comprises a geometric operator that maps the low-resolution sub-frame to a hypothetical high-resolution grid, such as operator Fₖ described in greater detail below by Equation III and FIGS. 4 and 7. Generation of the low-resolution sub-frames comprises an iterative process as described in greater detail below by FIGS. 4 and 7, with an initial guess for each low-resolution sub-frame being determined as described in greater detail below by FIGS. 5 and 8.

At 238, and as described above by FIGS. 1 and 2A-2C, the low-resolution sub-frames generated at 236 are simultaneously projected by the associated projector onto a target surface to form a projected image which is substantially equal to the high-resolution image.

FIG. 4 is a diagram illustrating a model of an image formation process according to one embodiment of the present invention. The sub-frames 110 are represented in the model by Yₖ, where “k” is an index for identifying the individual projectors 112. Thus, Y₁, for example, corresponds to a sub-frame 110A for a first projector 112A, Y₂ corresponds to a sub-frame 110B for a second projector 112B, etc. As will be described in greater detail below, the pixels of sub-frames Yₖ comprise linearized relative luminance values, the values being relative to the k^{th} projector's peak luminance. It is also noted that sub-frame Yₖ represents a “complete” frame to be projected by the k^{th} projector, but is a “sub-frame” with respect to the desired high resolution image 308(X).

Two of the sixteen pixels of the sub-frame 110 shown in FIG. 4 are highlighted, and identified by reference numbers 300A-1 and 300B-1. The sub-frames 110 (Yₖ) are represented on a hypothetical high-resolution grid by up-sampling (represented by D^{T}) to create up-sampled image 301. The up-sampled image 301 is filtered with an interpolating filter (represented by Hₖ) to create a high-resolution image 302 (Rₖ) with “chunky pixels”. This relationship is expressed in the following Equation I:
Rₖ=HₖD^{T}Yₖ Equation I
where:
   k=index for identifying the projectors 112;
   Rₖ=low-resolution sub-frame 110 of the kth projector 112 on a hypothetical high-resolution grid;
   Hₖ=Interpolating filter for low-resolution sub-frame 110 from k^{th} projector 112;
   D^{T}=up-sampling matrix; and
   Yₖ=low-resolution sub-frame 110 of the k^{th} projector 112.

The low-resolution sub-frame pixel data (Yₖ) is expanded with the up-sampling matrix (D^{T}) so that the sub-frames 110 (Yₖ) can be represented on a high-resolution grid. The interpolating filter (Hₖ) fills in the missing pixel data produced by up-sampling. In the embodiment shown in FIG. 4, pixel 300A-1 from the original sub-frame 110 (Yₖ) corresponds to four pixels 300A-2 in the high-resolution image 302 (Rₖ), and pixel 300B-1 from the original sub-frame 110 (Yₖ) corresponds to four pixels 300B-2 in the high-resolution image 302 (Rₖ). The resulting image 302 (Rₖ) in Equation I models the output of the k^{th} projector 112 if there was no relative distortion or noise in the projection process.

Relative geometric distortion between the projected component sub-frames 110 is due to the different optical paths and locations of the component projectors 112. A geometric transformation is modeled with the operator, Fₖ, which maps coordinates in the frame buffer 113 of the k^{th} projector 112 to the frame buffer 120 of the reference projector 118 (FIG. 1) with sub-pixel accuracy, to generate a warped image 304 (R_{ref}). In one embodiment, Fₖ is linear with respect to pixel intensities, but is non-linear with respect to the coordinate transformations. As shown in FIG. 4, the four pixels 300A-2 in image 302 (Rₖ) are mapped to the three pixels 300A-3 in image 304, and the four pixels 300B-2 in image 302 (Rₖ) are mapped to the four pixels 300B-3 in image 304.

In one embodiment, the geometric mapping (Fₖ) is a floating-point mapping, but the destinations in the mapping are on an integer grid in image 304. Thus, it is possible for multiple pixels in image 302 (Rₖ) to be mapped to the same pixel location in image 304 (R_{ref}), resulting in missing pixels in image 304. To avoid this situation, in one form of the present invention, during the forward mapping (Fₖ), the inverse mapping (Fₖ⁻¹) is also utilized as indicated at 305 in FIG. 4. Each destination pixel in image 304 (R_{ref}) is back projected (i.e., Fₖ⁻¹), as illustrated at 305, to find the corresponding location in image 302 (Rₖ). For the embodiment shown in FIG. 4, the location in image 302 (Rₖ) corresponding to the upper-left pixel of the pixels 300A-3 in image 304 (R_{ref}) is the location at the upper-left corner of the group of pixels 300A-2. In one form of the invention, the values for the pixels neighboring the identified location in image 302 (Rₖ) are combined (e.g., averaged) to form the value for the corresponding pixel in image 304 (R_{ref}). Thus, for the example shown in FIG. 4, the value for the upper-left pixel in the group of pixels 300A-3 in image 304 (R_{ref}) is determined by averaging the values for the four pixels within the frame 303 in image 302 (Rₖ).

In another embodiment of the invention, the forward geometric mapping or warp (Fₖ) is implemented directly, and the inverse mapping (Fₖ⁻¹) is not used. In one form of this embodiment, a scatter operation is performed to eliminate missing pixels. That is, when a pixel in image 302 (Rₖ) is mapped to a floating point location in image 304(R_{ref}), some of the image data for the pixel is essentially scattered to multiple pixels neighboring the floating point location in image 304 (R_{ref}). Thus, each pixel in image 304 (R_{ref}) may receive contributions from multiple pixels in image 302 (Rₖ), and each pixel in image 304 (R_{ref}) is normalized based on the number of contributions it receives.

A relative luminance profile, Lₖ, models the linearized spatial luminance response of the k^{th} component projector 112 relative to the combined luminance response of all component projectors 112. The determination of relative luminance profile Lₖ is described in greater detail below with respect to FIG. 6. Relative luminance profile Lₖ is applied to warped image 304 (R_{ref}) to generate a weighted-warped image (R^{w}_{ref}, not shown) (i.e. LₖFₖRₖ) having pixel values weighted according to the relative luminance response of the k^{th} component projector 112. In this fashion, weighted-warped image (R^{w}_{ref}) accounts for luminance variations between the corresponding projected component sub-frames 110 of each of the component projectors 112.

A superposition/summation of the weighted-warped images (R^{w}_{ref}) of each the component projectors 112 forms a hypothetical or simulated high-resolution image 306 (X-hat) in the reference projector frame buffer 120, as represented in the following Equation II:
\hat{X}=ΣLₖFₖRₖ Equation II
where:
   k=index for identifying the projectors 112;
   X-hat=hypothetical or simulated high-resolution image 306 in the reference projector frame buffer 120;
   Lₖ=relative luminance profile of k^{th} projector.
   Fₖ=operator that maps a low-resolution sub-frame 110 of the k^{th} projector 112 on a hypothetical high-resolution grid to the reference projector frame buffer 120; and
   Rₖ=low-resolution sub-frame 110 of k^{th} projector 112 on a hypothetical high-resolution grid, as defined in Equation I.

If the simulated high-resolution image 306 (X-hat) in the reference projector frame buffer 120 is identical to the given (desired) high-resolution image 308 (X), the system of component low-resolution projectors 112 would be equivalent to a hypothetical high-resolution projector placed at the same location as the reference projector 118 and sharing its optical path. In one embodiment, the desired high-resolution images 308 are the high-resolution image frames 106 (FIG. 1) received by sub-frame generator 108.

In one embodiment, if the simulated high-resolution image 306 (X-hat) in the reference projector frame buffer 120 deviates too far from the desired high-resolution image 308 (X), the sub-frames 110 (Yₖ) are updated iteratively according to the following Equation III:
Yₖ^{(n+)=Y}ₖ^{(n)+αDH}ₖ^{T}Fₖ^{T}Lₖ^{T}{X−\hat{X}} Equation III:
where:
   k=index for identifying the projectors 112;
   n=index for identifying the number of iterations;
   Yₖ⁽ⁿ⁺¹⁾=next low-resolution sub-frame 110 of the k^{th} projector 112;
   Yₖ⁽ⁿ⁾=present low-resolution sub-frame 110 of the k^{th} projector 112;
   X=desired high-resolution image frame 308;
   X-hat=hypothetical or simulated high-resolution image frame 306 in the reference projector frame buffer;
   α=momentum parameter indicating the fraction of error to be incorporated at each iteration
   Lₖ^{T}=Transpose of relative luminance profile Lₖ;
   D=down-sampling matrix;
   Hₖ^{T}=Transpose of interpolating filter Hₖ from Equation I.
   Fₖ^{T}=Transpose of operator Fₖ from Equation II (the inverse of the warp denoted by Fₖ).
      In this fashion, the sub-frame 110 (Yₖ) for each component projector 112 is iteratively adjusted based on each projector's relative contribution to the simulated high-resolution image 306 (X-hat).

Because the luminance values of the sub-frames Yₖ of each of the component projectors 112 comprise linearized relative values, the values cannot be input directly to the corresponding projector for projection. As such, when the simulated high-resolution image 306 (X-hat) is determined to be substantially equal to the desired high-resolution image 308 (X), the values of sub-frames Yₖ are gamma-corrected prior to providing the data values to the corresponding component projector 112 for projection.

In one embodiment, the deviation of the simulated high-resolution image 306 (X-hat) from the desired high-resolution image 308 (X) is modeled as shown in the following Equation IV:
X=\hat{X}+η Equation IV
where:
   X=desired high-resolution frame 308;
   X-hat=hypothetical or simulated high-resolution frame 306 in the reference projector frame buffer 120; and
   η=error or noise term.

As shown in Equation IV, the desired high-resolution image 308 (X) is defined as the simulated high-resolution image 306 (X-hat) plus η, which in one embodiment represents zero mean white Gaussian noise.

The solution for the optimal sub-frame data (Yₖ*) for the sub-frames 110 is formulated as the optimization given in the following Equation V:

$${Y}_{k}^{*} = {arg max}_{{Y}_{k}} P ( \hat{X} \text{\vert} X ) \qquad Equation V$$

where:
   k=index for identifying the projectors 112;
   Yₖ*=optimum low-resolution sub-frame 110 of the k^{th} projector 112;
   Yₖ=low-resolution sub-frame 110 of the k^{th} projector 112;
   X-hat=hypothetical or simulated high-resolution frame 306 in the reference projector frame buffer 120, as defined in Equation II;
   X=desired high-resolution frame 308; and
   P(X-hat|X)=probability of X-hat given X.

Thus, as indicated by Equation V, the goal of the optimization is to determine the sub-frame values (Yₖ) that maximize the probability of X-hat given X. Given a desired high-resolution image 308 (X) to be projected, sub-frame generator 108 (FIG. 1) determines the component sub-frames 110 that maximize the probability that the simulated high-resolution image 306 (X-hat) is the same as or matches the “true” high-resolution image 308 (X).

Using Bayes rule, the probability P(X-hat|X) in Equation V can be written as shown in the following Equation VI:

$$P ( \hat{X} \text{\vert} X ) = \frac{P ( X \text{\vert} \hat{X} ) P ( \hat{X} )}{P ( X )} \qquad Equation VI$$

where:
   X-hat=hypothetical or simulated high-resolution frame 306 in the reference projector frame buffer 120, as defined in Equation II;
   X=desired high-resolution frame 308;
   P(X-hat|X)=probability of X-hat given X;
   P(X|X-hat)=probability of X given X-hat;
   P(X-hat)=prior probability of X-hat; and
   P(X)=prior probability of X.

The term P(X) in Equation VI is a known constant. If X-hat is given, then, referring to Equation IV, X depends only on the noise term, η, which is Gaussian. Thus, the term P(X|X-hat) in Equation V will have a Gaussian form as shown in the following Equation VII:

$$P ( X \text{\vert} \hat{X} ) = \frac{1}{C} {e}^{\frac{{‖ X - \hat{X} ‖}^{2}}{2 {σ}^{2}}} \qquad Equation VII$$

where:
   X-hat=hypothetical or simulated high-resolution frame 306 in the reference projector frame buffer 120, as defined in Equation II;
   X=desired high-resolution frame 308;
   P(X|X-hat)=probability of X given X-hat;
   C=normalization constant; and
   σ=variance of the noise term, η.

To provide a solution that is robust to minor calibration errors and noise, a “smoothness” requirement is imposed on X-hat. In other words, it is assumed that good simulated images 306 have certain properties. The smoothness requirement according to one embodiment is expressed in terms of a desired Gaussian prior probability distribution for X-hat given by the following Equation VIII:

$$P ( \hat{X} ) = \frac{1}{Z ( β )} {ⅇ}^{- \{ {β}^{2} ( {‖ ∇ \hat{X} ‖}^{2} ) \}} \qquad Equation VIII$$

where:
   P(X-hat)=prior probability of X-hat;
   β=smoothing constant;
   Z(β)=normalization function;
   ∇=gradient operator; and
   X-hat=hypothetical or simulated high-resolution frame 306 in the reference projector frame buffer 120, as defined in Equation II.

In another embodiment of the invention, the smoothness requirement is based on a prior Laplacian model, and is expressed in terms of a probability distribution for X-hat given by the following Equation IX:

$$P ( \hat{X} ) = \frac{1}{Z ( β )} {ⅇ}^{- \{ β ( ‖ ∇ \hat{X} ‖ ) \}} \qquad Equation IX$$

where:
   P(X-hat)=prior probability of X-hat;
   β=smoothing constant;
   Z(β)=normalization function;
   ∇=gradient operator; and
   X-hat=hypothetical or simulated high-resolution frame 306 in the reference projector frame buffer 120, as defined in Equation II.

The following discussion assumes that the probability distribution given in Equation VIII, rather than Equation IX, is being used. As will be understood by persons of ordinary skill in the art, a similar procedure would be followed if Equation IX were used. Inserting the probability distributions from Equations VII and VIII into Equation VI, and inserting the result into Equation V, results in a maximization problem involving the product of two probability distributions (note that the probability P(X) is a known constant and goes away in the calculation). By taking the negative logarithm, the exponents go away, the product of the two probability distributions becomes a sum of two probability distributions, and the maximization problem given in Equation V is transformed into a function minimization problem, as shown in the following Equation X:

$${Y}_{k}^{*} = {arg min}_{{Y}_{k}} {‖ X - \hat{X} ‖}^{2} + {β}^{2} {‖ ∇ \hat{X} ‖}^{2} \qquad Equation X$$

where:
   k=index for identifying the projectors 112;
   Yₖ*=optimum low-resolution sub-frame 110 of the kth projector 112;
   Yₖ=low-resolution sub-frame 110 of the kth projector 112;
   X-hat=hypothetical or simulated high-resolution frame 306 in the reference projector frame buffer 120, as defined in Equation II;
   X=desired high-resolution frame 308;
   β32 smoothing constant; and
   ∇=gradient operator.

The function minimization problem given in Equation X is solved by substituting the definition of X-hat from Equation II into Equation X and taking the derivative with respect to Yₖ, which results in an iterative algorithm given by the following Equation XI:
Yₖⁿ⁺¹⁾=Yₖ⁽ⁿ⁾−Θ{DHₖ^{T}Fₖ^{T}└(\hat{X}⁽ⁿ⁾−X)+β²∇²\hat{X}⁽ⁿ⁾┘} Equation XI
where:
   k=index for identifying the projectors 112;
   n=index for identifying iterations;
   Yₖ⁽ⁿ⁺¹⁾=low-resolution sub-frame 110 for the kth projector 112 for iteration number n+1;
   Yₖ⁽ⁿ⁾=low-resolution sub-frame 110 for the kth projector 112 for iteration number n;
   Θ=momentum parameter indicating the fraction of error to be incorporated at each iteration;
   D=down-sampling matrix;
   Hₖ^{T}=Transpose of interpolating filter, Hₖ, from Equation I (in the image domain, Hₖ^{T} is a flipped version of Hₖ);
   Fₖ^{T}=Transpose of operator, Fₖ, from Equation II (in the image domain, Fₖ^{T} is the inverse of the warp denoted by Fₖ);
   X-hat⁽ⁿ⁾=hypothetical or simulated high-resolution frame 306 in the reference projector frame buffer 120, as defined in Equation II, for iteration number n;
   X=desired high-resolution frame 308;
   β=smoothing constant; and
   ∇²=Laplacian operator.

Equation XI may be intuitively understood as an iterative process of computing an error in the reference projector 118 coordinate system and projecting it back onto the sub-frame data. In one embodiment, sub-frame generator 108 (FIG. 1) is configured to generate sub-frames 110 in real-time using Equation XI. The generated sub-frames 110 are optimal in one embodiment because they maximize the probability that the simulated high-resolution image 306 (X-hat) is the same as the desired high-resolution image 308 (X), and they minimize the error between the simulated high-resolution image 306 and the desired high-resolution image 308. Equation XI can be implemented very efficiently with conventional image processing operations (e.g., transformations, down-sampling, and filtering). The iterative algorithm given by Equation XI converges rapidly in a few iterations and is very efficient in terms of memory and computation (e.g., a single iteration uses two rows in memory; and multiple iterations may also be rolled into a single step). The iterative algorithm given by Equation XI is suitable for real-time implementation, and may be used to generate optimal sub-frames 110 at video rates, for example.

To begin the iterative algorithm defined in Equation XI, an initial guess, Yₖ⁽⁰⁾, for the sub-frames 110 is determined. FIG. 5 is a diagram illustrating one embodiment of a process for determining initial sub-frame guess Yₖ⁽⁰⁾. An image frame 106 (X′) of the high resolution image to be displayed by image display system 100 is received by sub-frame generator 108. Typically, as illustrated, image frame 106 (X′) is received from the providing image device (e.g. a digital camera) comprising gamma-corrected (γ) pixel values. Generally, the gamma correction value of the imaging device is a known parameter and is provided as part of the image data 102. If not, an estimated gamma correction value can be determined by sub-frame generator 108. Based on the gamma value, sub-frame generator 108 performs a de-gamma operation (γ⁻¹) to form the desired high-resolution frame 308 (X) with pixels having linearized data values. In one embodiment, as illustrated by the processes of FIGS. 4 and 5, the values of high-resolution image frame 308(X) are normalized so as to comprise normalized linear luminance values ranging between values of “0” and “1.”

The initial guess, Yₖ⁽⁰⁾, for sub-frames 110 is determined from high-resolution frame 308 (X). In one embodiment, the initial guess for the sub-frames 110 is determined by texture mapping the desired high-resolution frame 308 onto the sub-frames 110. In one form of the invention, the initial guess is determined from the following Equation XII:
Yₖ⁽⁰⁾=DBₖFₖ^{T}X Equation XII
where:
   k=index for identifying the projectors 112;
   Yₖ⁽⁰⁾=initial guess at the sub-frame data for the sub-frame 110 for the kth projector 112;
   D=down-sampling matrix;
   Bₖ=interpolation filter;
   Fₖ^{T}=Transpose of operator, Fₖ, from Equation II (in the image domain, Fₖ^{T} is the inverse of the warp denoted by Fₖ); and
   X=desired high-resolution frame 308.

Thus, as indicated by Equation XII, the initial guess (Yₖ⁽⁰⁾) is determined by performing a geometric transformation (Fₖ^{T}) on the desired high-resolution frame 308 (X), and filtering (Bₖ) and down-sampling (D) the result. The particular combination of neighboring pixels from the desired high-resolution frame 308 that are used in generating the initial guess (Yₖ⁽⁰⁾) will depend on the selected filter kernel for the interpolation filter (Bₖ).

In another form of the invention, as illustrated by FIG. 5, the initial guess, Yₖ⁽⁰⁾, for the sub-frames 110 is determined from the following Equation XIII:
Yₖ⁽⁰⁾=DFₖ^{T}X Equation XIII
where:
   k=index for identifying the projectors 112;
   Yₖ⁽⁰⁾=initial guess at the sub-frame data for the sub-frame 110 for the kth projector 112;
   D=down-sampling matrix;
   Fₖ^{T}=Transpose of operator, Fₖ, from Equation II (in the image domain, Fₖ^{T} is the inverse of the warp denoted by Fₖ); and
   X=desired high-resolution frame 308.

Equation XIII is the same as Equation XII, except that the interpolation filter (Bₖ) is not used.

Several techniques are available to determine the geometric mapping (Fₖ) between each projector 112 and the reference projector 118, including manually establishing the mappings, or using camera 122 and calibration unit 124 (FIG. 1) to automatically determine the mappings. In one embodiment, if camera 122 and calibration unit 124 are used, the geometric mappings between each projector 112 and the camera 122 are determined by calibration unit 124. These projector-to-camera mappings may be denoted by Tₖ, where k is an index for identifying projectors 112. Based on the projector-to-camera mappings (Tₖ), the geometric mappings (Fₖ) between each projector 112 and the reference projector 118 are determined by calibration unit 124, and provided to sub-frame generator 108. For example, in a display system 100 with two projectors 112A and 112B, assuming the first projector 112A is the reference projector 118, the geometric mapping of the second projector 112B to the first (reference) projector 112A can be determined as shown in the following Equation XIV:
F₂=T₂T₁⁻¹ Equation XIV
where:
   F₂=operator that maps a low-resolution sub-frame 110 of the second projector 112B to the first (reference) projector 112A;
   T₁=geometric mapping between the first projector 112A and the camera 122; and
   T₂=geometric mapping between the second projector 112B and the camera 122.

In one embodiment, the geometric mappings (Fₖ) are determined once by calibration unit 124, and provided to sub-frame generator 108. In another embodiment, calibration unit 124 continually determines (e.g., once per frame 106) the geometric mappings (Fₖ), and continually provides updated values for the mappings to sub-frame generator 108.

FIG. 6 is a flow diagram describing one embodiment of a process 330 for determining relative luminance profiles Lₖ (as employed by Equation II above) for the component projectors 112 of image display system 100 according to the present invention. Process 330 begins at 332 where the luminance curve (i.e. gamma) of a selected one of the component projectors 112 is determined. In one embodiment, the luminance curve is determined by providing a series of known input values to the selected projector and measuring the selected projector's output luminance. Based on the non-linear output of the selected projector in response to the series of known input values, the luminance curve (i.e. gamma correction) of the selected projector is determined.

At 334, an inverse of the luminance curve determined above at 332 is applied to a series of input values to generate a series of pre-corrected input values. The series of pre-corrected input values are applied to the selected projector such that the selected projector functions as a linearized light projection device. The luminance output of the selected projector in response to the series of pre-corrected input values is captured with a digital camera or other suitable image capturing device. Based on the image data values captured by the camera at each of the pre-corrected input values, the gamma curve of the camera is determined.

In one embodiment, the luminance curve of each of the component projectors 112 is determined and each projector is employed to project a same series of pre-corrected data values. The corresponding luminance values captured by the camera are then integrated to determine the gamma curve (at 334) of the camera to thereby reduce potential effects resulting from noise.

At 336, data values representative of a selected gray level are applied to and projected by a first component projector 112 of the imaging system 100. At 338, the projected output of the component projector 112 in response to the selected gray level input is captured by the camera. The gamma curve of the camera, as determined at 334, is applied to the captured luminance values to linearize the captured luminance values.

Process 330 proceeds to 340 where the linearized luminance values are “warped” to the high-resolution grid, which is also referred to herein as projector space. Generally, the resolution of the camera does not match the resolution of the high-resolution image which is desired to be projected, with the number of pixels of the image captured by the camera generally being less than the number of pixels of the desired high resolution image. As such, at 340, an up-sampling matrix, an interpolating filter, and a geometric mapping (similar to Fₖ, Hₖ, and D^{T} described above by Equations I and II with respect to formation of images Rₖand R_{ref}) are applied to the output data captured by the camera to expand and map (commonly referred to as “warping”) the captured image to the high-resolution grid and generate an absolute linear luminance profile (Lₖ′) for the component projector 112. Alternatively, a texture mapping method, as is well-known in the art, can be employed to map the output data captured by the camera from the coordinate system of the camera to the coordinate system of the desired high resolution image.

At 342, process 330 queries whether the projector whose absolute linear luminance profile L′ₖ was just determined at 340 is the final component projector 112 of image display system 100. If the answer to the query is “no”, process 330 returns to 336 and repeats 336 through 340 to determine the absolute linear luminance profile L′ₖ of the next component projector 112 of image display system 100.

If the answer to the query at 342 is “yes”, process 330 proceeds to 344 where the absolute linear luminance profile, L′ₖ, of each of the component projectors 112 are normalized across space to determine the relative luminance profile (Lₖ) for each component projector 112. The relative luminance profile, Lₖ, for each projector is employed as described above by FIG. 4 to determine an optimal sub-frame Yₖ for each component projector 112 such that the summation of the sub-frames Yₖ of all projectors 112 (as described by Equation II above) is substantially equal to the desired high-resolution image 308 (X).

In one embodiment of process 330, in lieu of warping the output data captured by the camera “up to” the high-resolution grid at 340, the absolute linear luminance profile, Lₖ′, for each component projector 112 is formed by warping the output data captured by the camera “down to” the low-resolution sub-frame coordinate system. The absolute linear luminance profiles, Lₖ′, are then normalized at 344 such that the relative luminance profile, Lₖ, for each component projector 112 is with respect to the low-resolution sub-frame coordinate system in lieu of the high-resolution grid. In such an embodiment, with reference to FIG. 4, the relative luminance profile, Lₖ, is applied to low-resolution sub-frame (Y_{K}) 110 prior to up-sampling matrix, D^{T}, as part of the process to form up-sampled image 301 rather than being applied to image 304 (R_{ref}). Additionally, Equation III is modified such that relative luminance profile, Lₖ, is applied subsequent to down-sampling matrix, D, rather than being applied prior to the Fₖ^{T} operator.

In one embodiment, as illustrated at 346, process 330 adjusts the luminance values captured by the camera at 338 to compensate for any spatial variance that may exist in the camera's image sensor. Similar to the spatial variance described above with respect to component projectors 112, there may also be a spatial variance across the camera's image sensor. In one embodiment, to determine the camera's spatial variance, a known “flat-field” luminance field is provided and captured with the camera. The luminance values captured by the camera in response to the known flat-field are then linearized using the camera's gamma curve, as determined at 334 above, to determine an absolute linear spatial variance (V_{C}) of the camera. At 346, an inverse of the absolute linear spatial variance (V_{C}⁻¹) of the camera is applied to the linearized luminance values determined at 338 to adjust for any spatial variance contributions of the camera. These adjusted linearized luminance values are then “warped” to a desired reference grid or coordinate system as described at 340.

In one embodiment of the present invention, as illustrated by FIGS. 6 and 7 below, sub-frame generator 108 is configured to generate sub-frames (Zₖ) comprising absolute linearized luminance values in lieu of sub-frames (Yₖ) comprising relative linearized luminance values (as described above by FIGS. 4 and 5).

At least a portion of projected light from each of the component projectors 112 results from ambient light contributions, which is in addition to light projected in response to received image data. As such, due to ambient light, a certain amount of light will be projected by each component projector 112 of image display system 100 even when in an “off” state. During operation, such ambient light contributions can affect the quality of the projected image.

As such, in one embodiment of the present invention, a process similar to that for determining the relative luminance profile, Lₖ, for each component projector 112 as described above by FIG. 6 is employed to determine an ambient luminance profile, L_{A}, for image display system 100. To determine the ambient luminance profile, L_{A}, each of the component projectors 112 of display system 100 is turned off and a digital camera (such as described above by process 330 of FIG. 6) is employed to capture ambient light projected onto target surface 116 (see FIG. 1). The captured image is then “warped-up” to the high-resolution grid to form an absolute ambient luminance profile, L_{A}′, for the system. The absolute ambient luminance profile, L_{A}′, is translated to linear data values to form ambient luminance profile L_{A} for the system.

In one embodiment, with respect to FIG. 5, the ambient luminance profile, L_{A}, is subtracted from the linearized data values of the desired high-resolution image 308 (X) prior to the linearized data values being normalized. During projection of image 114 corresponding to high-resolution image frame 308 (X), the ambient light contributions are inherently included as part of the projected image.

FIG. 7 is a diagram illustrating a model of an image formation process for modeling sub-frames 110, wherein the sub-frames 110 comprise absolute linearized luminance values represented as sub-frames 110 (Zₖ), where “k” is an index for identifying the individual component projectors 112. Thus, Z₁, for example, corresponds to a sub-frame for a first projector 112A, Y₂ corresponds to a sub-frame 110B for a second projector 112B, etc.

The image formation process for modeling sub-frames 110 Zₖ is similar to that for generating sub-frames Yₖ as described above by FIG. 4. As such, sub-frames 110 (Zₖ) are represented on a hypothetical high-resolution grid by up-sampling (represented by D^{T}) to create an up-sampled image 401. The up-sampled image 401 is filtered with an interpolating filter (represented by Hₖ) to create a high-resolution image 402 (Rₖ) with “chunky” pixels. This relationship is expressed in a fashion similar to that expressed above by Equation I. In a fashion similar to that described above by FIG. 4, a geometric transformation (Fₖ) is modeled which maps coordinates in the frame buffer 113 of the k^{th} projector 112 to a warped image 404 (R_{ref}).

In a fashion similar to that described above by Equation II, a summation of the warped images 404 (R_{ref}) of each of the component projectors 112 forms a hypothetical or simulated-high resolution image 406 (X-hat). However, unlike Equation II and the image formation process of FIG. 4, since the values of sub-frames Zₖ are in terms of absolute linearized luminance values, the values of warped images 404 (R_{ref}) are not “weighted” by a relative luminance profile Lₖ, prior to their summation to form for simulated high-resolution image 406 (X-hat).

If the simulated high-resolution image 406 (X-hat) in the reference projector frame buffer 120 is identical to the given (desired) high-resolution image 408 (X), the system of component low-resolution projectors 112 would be equivalent to a hypothetical high-resolution projector placed at the same location as the reference projector 118 and sharing its optical path. In one embodiment, the desired high-resolution images 408 are the high-resolution image frames 106 (FIG. 1) received by sub-frame generator 108.

In one embodiment, if the simulated high-resolution image 406 (X-hat) in the reference projector frame buffer 120 deviates too far from the desired high-resolution image 408 (X), an iterative process (similar to that described above by Equation III) is employed to determine values for sub-frames 110 (Zₖ) which will form desired high-resolution image 408(X). In one embodiment, this iterative process is represented by the following Equation XV:
Zₖ⁽ⁿ⁺¹⁾=Zₖ⁽ⁿ⁾+αDHₖ^{T}Fₖ^{T}{X−\hat{X}} Equation XV:
where:
   k=index for identifying the projectors 112;
   n=index for identifying the number of iterations;
   Zₖ⁽ⁿ⁺¹⁾=next low-resolution sub-frame 110 of the k^{th} projector 112;
   Zₖ⁽ⁿ⁾=present low-resolution sub-frame 110 of the k^{th} projector 112;
   X=desired high-resolution image frame 308;
   X-hat=hypothetical or simulated high-resolution image frame 306 in the reference projector frame buffer;
   α=momentum parameter indicating the fraction of error to be incorporated at each iteration D=down-sampling matrix;
   Hₖ^{T}=Transpose of interpolating filter Hₖ from Equation I.
   Fₖ^{T}=Transpose of the operation Fₖ from Equation II (the inverse of the warp denoted by Fₖ).
      In this fashion, the sub-frame 110 (Zₖ) for each component projector 112 is iteratively adjusted based on each projector's absolute linearized luminance contribution to the simulated high-resolution image 406 (X-hat).

Since the values of the sub-frames Zₖ of each of the component projectors 112 comprise linearized absolute luminance values, sub-frames Zₖ cannot be directly provided to the corresponding projector for projection. As such, when the simulated high-resolution image 406 (X-hat) is determined to be substantially equal to the desired high-resolution image 408 (X), the values of sub-frames Zₖ are translated or mapped to provide data values for projection by the corresponding component projector 112 based on the projector's luminance curve (i.e. gamma curve). In one embodiment, this mapping or translation is represented by the following Equation XVI:
Zₖ′=Pₖ⁻¹Zₖ Equation XVI
where:
   k=index for identifying component projectors 112;
   Zₖ′=low-resolution sub-frame 110 of the k^{th} projector 112 on a hypothetical high-resolution grid (gamma-corrected data values);
   Pₖ⁻¹=operator that maps linear absolute luminance values to a data values for projection by the k^{th} projector.
   Zₖ=low-resolution sub-frame 110 of the k^{th} projector 112 (linear absolute luminance values).

In one embodiment, the operator Pₖ⁻¹ is based on the gamma curve, and on an absolute linear luminance profile corresponding to the k^{th} projector, similar to the luminance curve and absolute linear luminance profile L′ₖ as described respectively at 332 and 344 by process 330 of FIG. 6. In one embodiment, the absolute linear luminance profile L′ₖ is determined with the gray level of each projector substantially at a highest gray level output of the k^{th} projector.

To begin the image formation process described above by FIG. 7, an initial guess, Zₖ⁽⁰⁾, for the sub-frames 110 is determined. FIG. 8 is a diagram illustrating one embodiment of a process for determining initial sub-frame guess Zₖ⁽⁰⁾. An image frame 106 (X′of the high resolution image to be displayed by image display system 100 is received by sub-frame generator 108. Typically, as illustrated, image frame 106 (X′) is received from the providing image device (e.g. a digital camera) comprising gamma-corrected (γ) pixel values. Generally, the gamma correction value of the providing imaging is a known parameter and is provided as part of the image data 102. If not, an estimated gamma correction value can be determined by sub-frame generator 108.

Based on the gamma value, sub-frame generator 108 performs a de-gamma operation (γ⁻¹) to form the desired high-resolution frame 407 (X″) with pixels having linearized data values. The linearized data values of frame 407 (X″) are mapped to absolute linear luminance values within the full luminance range of the component projectors 112 (from ΣL_{MIN} to ΣL_{MAX}, as described above) to form a desired high-resolution image frame 408 (X).

In one embodiment, the linearized data values of each pixel of frame 407 (X″) are mapped with respect to a full luminance range of each pixel of the projector system. In one embodiment, the linearized data values of each pixel of frame 407 (X″) are mapped with respect to a full luminance range of all pixels of the projector system such that the relative “brightness” of the pixels with respect to one another remains the same. In one embodiment, in a fashion similar to that described above with regard to the process of FIGS. 3 and 4, the absolute ambient luminance profile, L_{A}′, is subtracted from high-resolution image frame 408(X) in order to compensate for ambient light contributions.

The initial guess, Zₖ⁽⁰⁾, for sub-frames 110 is determined from desired high-resolution frame 408 (X). In one embodiment, the initial guess for the sub-frames 110 is determined by texture mapping the desired high-resolution frame 408 onto the sub-frames 110. In one form of the invention, the initial guess is determined in a fashion similar to the described above by Equation XII. In one embodiment, the initial guess is determined a fashion similar to that described above by Equation XIII.

One form of the present invention provides an image display system 100 with multiple overlapped low-resolution projectors 112 coupled with an efficient real-time (e.g., video rates) image processing algorithm for generating sub-frames 110. In one embodiment, multiple low-resolution, low-cost projectors 112 are used to produce high resolution images 114 at high lumen levels, but at lower cost than existing high-resolution projection systems, such as a single, high-resolution, high-output projector. One form of the present invention provides a scalable image display system 100 that can provide virtually any desired resolution and brightness by adding any desired number of component projectors 112 to the system 100.

In some existing display systems, multiple low-resolution images are displayed with temporal and sub-pixel spatial offsets to enhance resolution. There are some important differences between these existing systems and embodiments of the present invention. For example, in one embodiment of the present invention, there is no need for circuitry to offset the projected sub-frames 110 temporally. In one form of the invention, the sub-frames 110 from the component projectors 112 are projected “in-sync”. As another example, unlike some existing systems where all of the sub-frames go through the same optics and the shifts between sub-frames are all simple translational shifts, in one form of the present invention, the sub-frames 110 are projected through the different optics of the multiple individual projectors 112. In one form of the invention, the signal processing model that is used to generate optimal sub-frames 110 takes into account relative geometric distortion among the component sub-frames 110, and is robust to minor calibration errors and noise.

It can be difficult to accurately align projectors into a desired configuration. In one embodiment of the invention, regardless of what the particular projector configuration is, even if it is not an optimal alignment, sub-frame generator 108 determines and generates optimal sub-frames 110 for that particular configuration.

Algorithms that seek to enhance resolution by offsetting multiple projection elements have been previously proposed. These methods assume simple shift offsets between projectors, use frequency domain analyses, and rely on heuristic methods to compute component sub-frames. In contrast, one form of the present invention utilizes an optimal real-time sub-frame generation algorithm that explicitly accounts for arbitrary relative geometric distortion (not limited to homographies) between the component projectors 112, including distortions that occur due to a target surface 116 that is non-planar or has surface non-uniformities. One form of the present invention generates sub-frames 110 based on a geometric relationship between a hypothetical high-resolution reference projector 118 at any arbitrary location and each of the actual low-resolution projectors 112, which may also be positioned at any arbitrary location.

In one embodiment, image display system 100 is configured to project images 114 that have a three-dimensional (3D) appearance. In 3D image display systems, two images, each with a different polarization, are simultaneously projected by two different projectors. One image corresponds to the left eye, and the other image corresponds to the right eye. Conventional 3D image display systems typically suffer from a lack of brightness. In contrast, with one embodiment of the present invention, a first plurality of the projectors 112 may be used to produce any desired brightness for the first image (e.g., left eye image), and a second plurality of the projectors 112 may be used to produce any desired brightness for the second image (e.g., right eye image). In another embodiment, image display system 100 may be combined or used with other display systems or display techniques, such as tiled displays.

Although specific embodiments have been illustrated and described herein, it will be appreciated by those of ordinary skill in the art that a variety of alternate and/or equivalent implementations may be substituted for the specific embodiments shown and described without departing from the scope of the present invention. This application is intended to cover any adaptations or variations of the specific embodiments discussed herein. Therefore, it is intended that this invention be limited only by the claims and the equivalents thereof.

What is claimed is:

1. A method of displaying a high-resolution image with a multi-projector display system, the method comprising:
determining a luminance profile for each projector;
receiving a high-resolution image frame representative of the high-resolution image;
generating for each projector a low-resolution sub-frame corresponding to the high-resolution image frame based on a geometric relationship between the projector and a reference coordinate system and on the luminance profile of the projector; and
simultaneously projecting each low-resolution sub-frame onto a target surface with the associated projector, wherein the projectors are configured such that the projected low-resolution sub-frames at least partially overlap on the target surface to form a projected image substantially equal to the high-resolution image.

2. The method of claim 1, wherein the luminance profile is spatially varying.

3. The method of claim 1, further comprising forming a desired high resolution image frame by linearizing and normalizing the high-resolution image frame.

4. The method of claim 3, wherein forming the desired high-resolution image frame further comprises determining an ambient luminance profile of the multi-projector system and adjusting the desired high-resolution image based on the ambient luminance profile.

5. The method of claim 3, wherein determining a luminance profile for each projector further comprises:
projecting a same gray level with each projector;
capturing the luminance values of the projected gray level of each projector;
linearizing the captured luminance values of each projector to provide an absolute linear luminance profile for each projector; and
forming the luminance profile of each projector by normalizing the absolute linear luminance profile of each projector with respect to the absolute linear luminance profiles of all projectors such that the luminance profile of each projector comprises a relative linear luminance profile.

6. The method of claim 5, wherein generating the low-resolution sub-frame for each projector further comprises geometrically transforming, filtering, and down-sampling the desired high resolution image frame.

7. The method of claim 6, further comprising generating a warped high-resolution image frame for each projector by geometrically up-sampling, filtering, and geometrically transforming the corresponding low-resolution sub-frame.

8. The method of claim 7, further comprising:
applying the relative linear luminance profile of each projector to the corresponding warped high-resolution image frame to generate a weighted high-resolution image frame;
summing the weighted high-resolution image frames of each of the projectors to form a simulated high-resolution image frame;
determining an error between the desired high resolution image frame and the simulated high resolution image frame; and
iteratively updating the low-resolution sub-frame of each projector based on the error until the simulated high-resolution image frame is substantially equal to the desired high-resolution image frame.

9. The method of claim 8, wherein updating the low-resolution sub-frame of each projector further comprises down-sampling, filtering, geometrically transforming, and applying a transpose of the relative linear luminance profile of the projector to the error.

10. The method of claim 8, further comprising gamma correcting the updated low-resolution sub-frames prior to projection by the corresponding projector.

11. The method of claim 6, further comprising generating a weighted low-resolution sub-frame for each projector by applying the relative linear luminance profile of the projector to the corresponding low-resolution sub-frame.

12. The method of claim 11, further comprising:
generating a warped high-resolution image frame for each projector by geometrically up-sampling, filtering, and geometrically transforming the corresponding weighted low-resolution sub-frame;
summing the warped high-resolution image frames of each of the projectors to form a simulated high-resolution image frame;
determining an error between the desired high resolution image frame and the simulated high resolution image frame; and
iteratively updating the low-resolution sub-frame of each projector based on the error until the simulated high-resolution image frame is substantially equal to the desired high-resolution image frame.

13. The method of claim 12, wherein iteratively updating the low-resolution sub-frame of each projector further comprises down-sampling, filtering, geometrically transforming, and applying a transpose of the relative linear luminance profile of the projector to the error.

14. The method of claim 3, wherein forming the desired high resolution image frame comprises mapping normalized linear luminance values of the high-resolution image frame over a full brightness range of the multi-projector display system so that the desired high resolution image frame comprises absolute linear luminance values.

15. The method of claim 14, wherein the normalized linear luminance values are mapped with respect to a full brightness range of each pixel of the multi-projector display system.

16. The method of claim 14, wherein the normalized linear luminance values are mapped with respect to a full brightness range of all pixels of the multi-projector display system.

17. The method of claim 14, wherein generating the low-resolution sub-frame for each projector further comprises geometrically transforming, filtering, and down-sampling the desired high resolution image frame.

18. The method of claim 17, further comprising:
generating a warped high-resolution image frame for each projector by geometrically up-sampling, filtering, and geometrically transforming the corresponding low-resolution sub-frame;
summing the warped high-resolution image frames of each projector to form a simulated high-resolution image;
determining an error between the desired high resolution image frame and the simulated high resolution image frame; and
iteratively updating the low-resolution sub-frame of each projector based on the error until the simulated high-resolution image frame is substantially equal to the desired high-resolution image frame.

19. The method of claim 18, wherein determining the luminance profile for each projector further comprises:
determining a luminance curve for each projector; and
determining a linear luminance profile comprising absolute luminance values at substantially a highest gray level output of each projector based on the corresponding luminance curve.

20. The method of claim 19, further comprising:
applying a mapping operator to translate the absolute linear luminance values of the updated low-resolution image frame of each projector to gamma-corrected data values for projection, wherein the mapping operator is based on the linear luminance profile and a gamma curve of the associated projector.

21. A display system for displaying a high-resolution image, the system comprising:
a plurality of projection devices, each projection device having a luminance profile;
a buffer configured to receive a high-resolution image frame representative of the high-resolution image;
a sub-frame generator configured to generate for each projection device a low-resolution sub-frame corresponding to the high-resolution image frame based on a geometric relationship between the projection device and a reference coordinate system and on the luminance profile of the projection device, wherein each projection device is configured to simultaneously project the associated low-resolution sub-frame onto a target surface such that the projected low-resolution sub-frames at least partially overlap on the target surface to form a projected image substantially equal to the high resolution image.

22. The display system of claim 21, wherein the sub-frame generator is configured to linearize and normalize the high-resolution image frame to form a desired high resolution image frame, and to geometrically transform, filter, and down-sample the desired high-resolution image frame to form the low-resolution sub-frame for each projection device.

23. The display system of claim 22, wherein the sub-frame generator is configured to up-sample, filter, and geometrically transform the low-resolution sub-frame of each projection device to form a warped high-resolution image frame for each projection device.

24. The display system of claim 23, wherein the low-resolution sub-frame and warped high-resolution image frame comprise normalized linear luminance values, and wherein the sub-frame generator is configured to linearize the luminance profile of each projection device based on the luminance curve of the projection device so as to provide a linear luminance profile for each projection device and configured to normalize the luminance curve of each projection device with respect to the linear luminance profile of all projection devices such that the luminance profile of each projection device comprises a relative linear luminance profile.

25. The display system of claim 24, wherein the sub-frame generator is configured to apply the relative linear luminance profile of each projection device to the corresponding warped high-resolution image frame to generate a weighted high resolution image frame, to sum the weighted high-resolution image frames of each of the projection devices to form a simulated high resolution image frame, to determine an error between the desired high-resolution image frame and the weighted high-resolution image frame, and to iteratively update the low-resolution sub-frame of each projection device based on the error until the simulated high-resolution image frame is substantially equal to the desired high-resolution image frame.

26. The display system of claim 25, wherein the sub-frame generator is configured to down-sample, filter, geometrically transform, and apply a transpose of the associated relative linear luminance profile of the projection device to the error before updating the low-resolution sub-frame of each projection device.

27. The display system of claim 23, wherein the sub-frame generator is configured to map the normalized linear luminance values of the high-resolution image frame over a full brightness range of the display system such that the desired high resolution image frame, low-resolution sub-frames, and warped high resolution image frame comprise absolute linear luminance values.

28. The display system of claim 27, wherein the sub-frame generator is configured to sum the warped high-resolution image frame of each projection device to form a simulated high resolution image frame, to determine an error between the desired and simulated high-resolution image frames, and to iteratively update the low-resolution sub-frames of each projection device based on the error so as to form an adjusted low-resolution sub-frame for each projection device.

29. The display system of claim 28, wherein the luminance profile of each projection device comprises an absolute linear luminance profile, and wherein the sub-frame generator is configured to map the absolute linear luminance values of the adjusted low-resolution sub-frame of each projection device to corresponding data values based on the absolute linear luminance profile and a gamma curve associated with each projection device.

30. The display system of claim 29, wherein the absolute linear luminance profile for each projection device is based on an associated luminance curve and on absolute linear luminance values corresponding to a substantially highest gray level output of the projection device.

31. A computer-readable medium having computer-executable instructions for performing a method of generating low-resolution sub-frames for simultaneous projection by a multi-projector display system to form a projected high-resolution image which substantially utilizes a full brightness of the display system, each projector having a luminance profile, the method comprising:
receiving a high-resolution image frame representative of the high-resolution image;
generating for each projector a low-resolution sub-frame corresponding to the high-resolution image frame based on a geometric relationship between the projector and a reference coordinate system and on the luminance profile of the projector; and
iteratively updating the low-resolution sub-frame for each projector based on an error between a desired high-resolution image frame and a simulated high-resolution image frame.

32. A display system comprising:
a plurality of projectors with each projector configured to project a corresponding low-resolution sub-frame at spatially offset positions on a target surface to form a projected image substantially equal to a high resolution image;
means for determining a luminance profile for each projector;
means for receiving a high-resolution image frame representative of the high resolution image;
means for generating the low-resolution sub-frame for each projector, the low-resolution sub-frame corresponding to the high-resolution image frame and based on a geometric relationship between the projector and a reference coordinate system and on the luminance profile of the projector; and
means for iteratively updating the low-resolution sub-frame for each projector based on an error between a desired high-resolution image frame and a simulated high resolution image frame until the simulated high-resolution image frame is substantially equal to a desired high-resolution image frame.
